(19) United States
(12) Patent Application Publication
(10) Pub. No.: US 2017/0138099 A1
(43) Pub. Date: May 18, 2017

(54) DOOR BRAKE SYSTEM, IN PARTICULAR FOR A MOTOR VEHICLE

(71) Applicant: GM GLOBAL TECHNOLOGY OPERATIONS LLC, Detroit, MI (US)

(72) Inventors: Marten WITTORF, Ruesselsheim (DE); Uwe SCHMITZ, Ruesselsheim (DE)

(73) Assignee: GM GLOBAL TECHNOLOGY OPERATIONS LLC, Detroit, MI (US)

(21) Appl. No.: 15/349,315

(22) Filed: Nov. 11, 2016

(30) Foreign Application Priority Data
Nov. 12, 2015 (DE) 202015007822.2

(51) Int. Cl. E05C 17/20; B60J 5/04; E05F 5/00; E05F 5/06; F16H 25/20; E05C 17/00

(52) U.S. Cl. CPC E05C 17/203; F16H 25/20; E05C 17/006; E05C 17/003; E05F 5/00; E05F 5/06; B60J 5/0468; E05Y 2201/21; E05Y 2201/694; E05Y 2201/22; E05Y 2201/232; E05Y 2201/26; E05Y 2201/434; E05Y 2201/696; E05Y 2400/20; E05Y 2400/44; E05Y 2400/54; E05Y 2900/531

(57) ABSTRACT

A door brake system for braking and locking a hinged door of a motor vehicle includes a stop and a base body, which is moved relative to the stop via a swiveling motion of the door. The base body is hinged and/or detachably fastened to the door. The stop is arranged on the door frame or on a body of the motor vehicle. The base body is guided relative to the stop in a positive manner to improve an effect and/or the kinematics of the door brake system.

### CROSS-REFERENCE TO RELATED APPLICATION

This application claims priority to German Patent Application No. 202015007822.2, filed Nov. 12, 2015, which is incorporated herein by reference in its entirety.

### TECHNICAL FIELD

The present disclosure pertains to particular to a door brake system for a hinged door, as well as to a motor vehicle with the door brake system.

### BACKGROUND

Door retaining straps are generally known, which are fastened to a motor vehicle door and include a counter-stop for braking the swiveling motion of a door by a body-side stop, and in particular locks the door in one position. However, there is a need to improve the braking, in particular locking, of a door, in particular of a motor vehicle, and/or to provide an improved door brake system, in particular for a motor vehicle.

### SUMMARY

In an embodiment of the present disclosure, a door brake system for braking and locking a hinged door of a motor vehicle. The door brake system includes a stop and a base body, which is moved relative to the stop via a swiveling motion of the door. In an embodiment, the base body is hinged and/or detachably fastened to the door. The stop is arranged on the door frame or bearing side, in particular on a body of the motor vehicle. In another embodiment, the stop is conversely arranged on the door and the base body is fastened to the door frame or bearing, in particular to a body of the motor vehicle.

In an embodiment, the base body is guided relative to the stop, in particular in a positive manner. In an embodiment, this makes it possible to improve an effect and/or the kinematics of the door brake system.

In a further development, the stop is arranged on the guide, in particular in a flexible manner. In an embodiment, this makes it possible to provide a compact arrangement.

In addition to the base body and stop, the door brake system in one embodiment may include the door and/or the door frame or a door bearing.

In an embodiment, the base body is moved, in particular by a swiveling motion of the door, relative to the stop in at least one degree of freedom, which is also referred to as the pull-out degree of freedom. In particular, the latter can also be a linear or rotational or turning degree of freedom. As a consequence, the base body in one embodiment is moved or displaced by a swiveling motion of the door axially and/or in the direction of its longitudinal axis relative to the stop.

In an embodiment, the base body is cast, in particular out of plastic. In an embodiment, this can advantageously reduce its weight and/or enable an advantageous contouring or shaping, in particular increase a design freedom.

In an embodiment, the base body is a so-called door retaining strap, which is pulled out of a door frame while opening the door, or designed for this purpose.

In an embodiment, the door brake system includes an adjustable counter-stop, which is arranged on the base body for braking a relative motion of the base body in the pull-out degree of freedom or relative to the stop by the stop that interacts with contacts, which brake a swiveling motion of the door. In an embodiment, this advantageously makes it possible to brake the swiveling motion, and in particular in so doing prevent or in any case reduce damage to the door swiveling open and/or by the door swiveling open.

In an embodiment, the door brake system includes an actuator, which is used to adjust the adjustable counter-stop, preferably continuously, on the base body. In a further development, this adjustment makes it possible to adjust a brake position of the base body in the pull-out degree of freedom or relative to the stop, and hence a brake position of the door, preferably continuously.

A brake position is here understood as a position of the base body relative to the stop, in particular a swiveled position of the door, in which a brake effect by the stop and the counter-stop interacting therewith arises, or a brake force imposed by the stop and the counter-stop interacting therewith or a brake torque imposed by the stop and the counter-stop interacting therewith reaches or exceeds a specific value, in particular a position in which the stop and counter-stop come into contact with each other.

In an embodiment, the actuator adjusts the adjustable counter-stop, in particular its position on the base body, reversibly in the direction of the pull-out degree of freedom, preferably selectively in a first or at least another position. In a further development, the stop and adjustable counter-stop come into contact with each other in a first swiveled position of the door when the adjustable counter-stop is adjusted in the first position on the base body, and come into contact with each other in another swiveled position of the door when the adjustable counter-stop is adjusted in another position on the base body.

In an embodiment, this advantageously makes it possible to vary a brake position of the door, and thus in particular adjust it to varying boundary conditions, in particular to available space and/or user preferences.

In an embodiment, the adjustable counter-stop is guided or mounted, preferably slideably mounted, in particular positively, adjustably, in particular displaceably, preferably axially displaceably, on the base body by a groove or web of the base body, in which at least one and preferably two or more carriages of the adjustable counter-stop are guided or mounted. In an embodiment, the actuator correspondingly displaces the adjustable counter-stop, preferably axially, on the base body. In an embodiment, this makes it possible to improve the wear and/or (adjusting) motion of the counter-stop.

In an embodiment, the actuator is an electric or electrically operable, and preferably controllable or a controlled actuator, and may include an electric motor or electromagnet. In an embodiment, this makes it possible to advantageously control actuation remotely and/or with a controller. In like manner, the actuator may in another embodiment be a hydraulic or pneumatic actuator.

In an embodiment, the actuator includes a driven rotary or output shaft for actuation purposes. In this way, an actuating force can be advantageously applied to the adjustable counter-stop in one embodiment. In like manner, the actuator can be a linear actuator in another embodiment, and preferably include an in particular electric, hydraulic or pneumatic linear motor.

In an embodiment, the actuator is fastened to the base body, preferably detachably fastened, through screwing, and/or to a side of the base body facing away from the door. In an embodiment, it can in this way be advantageously arranged, preferably in a door frame, and may be replaced as needed.

In an embodiment, the base body includes a counter-stop, which is spaced apart from the adjustable counter-stop, in particular axially, and fixed in place at least in the or in the direction of the pull-out degree of freedom, for braking a relative motion of the base body in the pull-out degree of freedom or relative to the stop, in particular for braking a swiveling motion of the door, by the stop interacting therewith, in particular in a fixed brake position different from the adjustable brake position.

In an embodiment, this makes it possible to advantageously provide a second, invariable, brake position within the swiveling range of the door so as to brake it in another position within the swiveling range. In an embodiment, the fixed counter-stop may be integral in design with the base body.

In an embodiment, the fixed brake position is arranged in the opening direction of the door before the adjustable brake position defined by the adjustable counter-stop. In particular, then, the adjustable brake position or adjustable counter-stop can define a potentially surmountable rear or end stop, so that the latter can in one embodiment advantageously be varied by adjusting the adjustable counter-stop with the actuator.

In another embodiment, the fixed brake position is arranged in the opening direction of the door after the adjustable brake position defined by the adjustable counter-stop. In particular, then, the fixed brake position or fixed counter-stop can define a potentially surmountable rear or end stop. In an embodiment, the stop and fixed counter-stop are arranged on opposite sides of the counter-stop, in particular for this purpose.

In an embodiment, the stop and adjustable counter-stop lock the base body in the pull-out degree of freedom or relative to the stop, and in a further development the door in so doing, in particular centered in a locked position, which can be adjusted or is adjusted by adjusting the counter-stop on the base body, or is designed for this purpose. Additionally or alternatively, the stop and fixed counter-stop lock the base body in the pull-out degree of freedom or relative to the stop, and in a further development the door in so doing, in particular centered in a fixed locked position.

Locking is here understood as the application of a resistance force or torque, in particular one elevated relative to the locked position of the adjacent region of the pull-out degree of freedom or swiveling range (for example, at least doubled) against a relative motion of the base body, or as a swiveling of the door out of the locked position in both directions. In other words, the stop and adjustable and/or fixed counter-stop in one embodiment have a dual or bilateral action so as to brake a relative motion of the base body in relation to the stop or a corresponding swiveling motion of the door in both directions.

In an embodiment, an adjustable or fixed locked position can encompass or denote an angular range of the swiveling range of the door, which in a further development measures no greater than 10°, preferably no greater than 5°, and most preferably no greater than 2°.

In an embodiment, the stop and/or in particular adjustable or fixed counter-stop can include at least one inclined run-up surface or ramp for braking purposes, and preferably two facing, opposite or oppositely inclined run-up surfaces or ramps for centered locking purposes.

In an embodiment, the door brake system includes a threaded spindle for adjusting the adjustable counter-stop with the actuator, which is operatively connected with the actuator and counter-stop. In an embodiment, this makes it possible realize an advantageous actuation to improve the transmission of a driving power of the actuator and/or a precision of the adjusting movement.

In an embodiment, the threaded spindle is rotationally coupled, and hereby operatively connected, with the actuator, in particular its drive shaft, for transmitting a torque around a longitudinal spindle axis.

In an embodiment, the threaded spindle includes a thread, preferably a male thread, into which engages at least one thread, preferably a female thread, of the adjustable counter-stop, and is hereby operatively connected with the latter. In an embodiment, such a thread of the counter-stop can be arranged on a carriage of the counter-stop guided in a groove or on a web of the base body. In an embodiment, this makes it possible to advantageously provide a compact arrangement and/or transmission of a torque of the actuator and/or its conversion into an actuating force in the actuating or displacement direction of the adjustable counter-stop.

In an embodiment, the threaded spindle is hinged or rotationally coupled with the actuator, in particular by at least one cardan joint. In an embodiment, this makes it possible for an output (rotational) angle of the actuator and a threaded spindle (rotational) axis to together include an angle different than 0°, and thereby each advantageously be arranged on the base body. Additionally or alternatively, a cardan joint or rotational coupling of the actuator with the threaded spindle in one embodiment makes it possible to advantageously provide the base body with a kinked design.

In another embodiment, the threaded spindle is connected or rotationally coupled with the actuator rigidly or in such a way that the rotational output axis of the actuator and threaded rotation spindle axis always align with each other. In particular, the threaded spindle can be or is rotationally coupled joint-free or directly with the actuator, in particular its output shaft. In an embodiment, this makes it possible to provide an advantageous, in particular uniform, conversion of a rotational motion of the actuator into a displacement movement of the adjustable counter-stop.

In an embodiment, the threaded spindle is rotatably mounted to the base body, in particular slideably mounted, and/or in two or more axially spaced apart bearings. In an embodiment, this makes it possible to provide a compact bearing of the threaded spindle and/or improve its movement, in particular its precision.

In an embodiment, the base body is shaped with the threaded spindle resultantly integrated therein, which in one embodiment can yield an advantageously compact and/or stable receptacle for the threaded spindle. In another embodiment, the base body includes at least two parts, which are joined tougher, in particular materially joined. the threaded spindle is arranged between these parts.

In an embodiment, the stop and adjustable and/or fixed counter-stop each include at least two contact surfaces for contacting the counter-stop or stop, which are arranged on opposite sides of the base body. In an embodiment, this makes it possible to improve the braking, in particular locking, by the stop, and the counter-stop that interacts therewith via the at least two contact surfaces lying opposite each other.

In an embodiment, the stop is pre-tensioned against the base body in an escape degree of freedom transverse to the pull-out degree of freedom of the base body, in particular in an escape direction transverse to the axial direction of the base body, in which the stop can be movably mounted on the guide that guides the base body, so as to be able to yield to the stop against the pre-tensioning and overcome or overrun the latter in this way. In an embodiment, the stop is pre-tensioned mechanically by a one- or multi-part spring element, hydraulically, pneumatically or magnetically. In an embodiment, the adjustable and/or fixed counter-stop is additionally or alternatively pre-tensioned against the stop in an escape degree of freedom transverse to the pull-out degree of freedom of the base body in an escape direction transverse to the axial direction of the base body, in which the counter-stop can be movably mounted on the base body, so as to be able to yield to the stop against the pre-tensioning and overcome or overrun the latter in this way. In an embodiment, the counter-stop is pre-tensioned mechanically by a one- or multi-part spring element, hydraulically, pneumatically or magnetically.

In an embodiment, the actuator for adjusting the adjustable counter-stop is controlled, in particular electronically and/or as a function of a user input and/or an acquired obstacle, in particular with a controller designed for this purpose. In an embodiment, the door brake system accordingly includes a controller for in particular electronically controlling the actuator for adjusting the adjustable counter-stop, in particular as a function of a user input and/or an acquired obstacle.

In an embodiment, the adjustable brake position, in particular locked position, can advantageously be changed as desired with a user input, for example, a swivel path between a closed position of the door and this position can be increased if needed, so as to facilitate entry and egress.

By making an adjustment as a function of an acquired obstacle, in particular within a space traversed by the door while it swivels within the swivel range, the adjustable brake, in particular locked position, can advantageously be determined in one embodiment in such a way that it brakes or locks the door before it reaches the obstacle. In particular, the swivel path between a closed position of the door and the adjustable brake, in particular locked position, can be reduced when an obstacle is acquired, so as to avoid a collision between the door and obstacle.

In the sense of the present disclosure, the adjustable brake position, and in particular the controller, can be implement as hardware or software and may include a digital processor or microprocessor unit (CPU) preferably data- or signal-connected with a memory and/or bus system, and/or one or more programs or program modules. The CPU can be designed to process commands implemented as a program stored in a memory system, acquire input signals from a data bus, and/or deliver output signals to a data bus. A memory system can include one or more, in particular various, memory media, in particular optical, magnetic, solid-state and/or other nonvolatile media. The program can be configured in such a way as to embody or be able to implement the methods described herein, so that the CPU can execute the steps in such a method, and thus in particular control the actuator.

### BRIEF DESCRIPTION OF THE DRAWINGS

The present disclosure will hereinafter be described in conjunction with the following drawing figures, wherein like numerals denote like elements.

FIG. 1 shows a door brake system according to an embodiment of the present disclosure in a perspective view;

FIG. 2 shows the door brake system on FIG. 1 in an axial section; and

FIG. 3 shows a portion of a door brake system according to another embodiment of the present disclosure in a perspective view with base body part removed.

### DETAILED DESCRIPTION

The following detailed description is merely exemplary in nature and is not intended to limit the invention or the application and uses of the invention. Furthermore, there is no intention to be bound by any theory presented in the preceding background of the invention or the following detailed description.

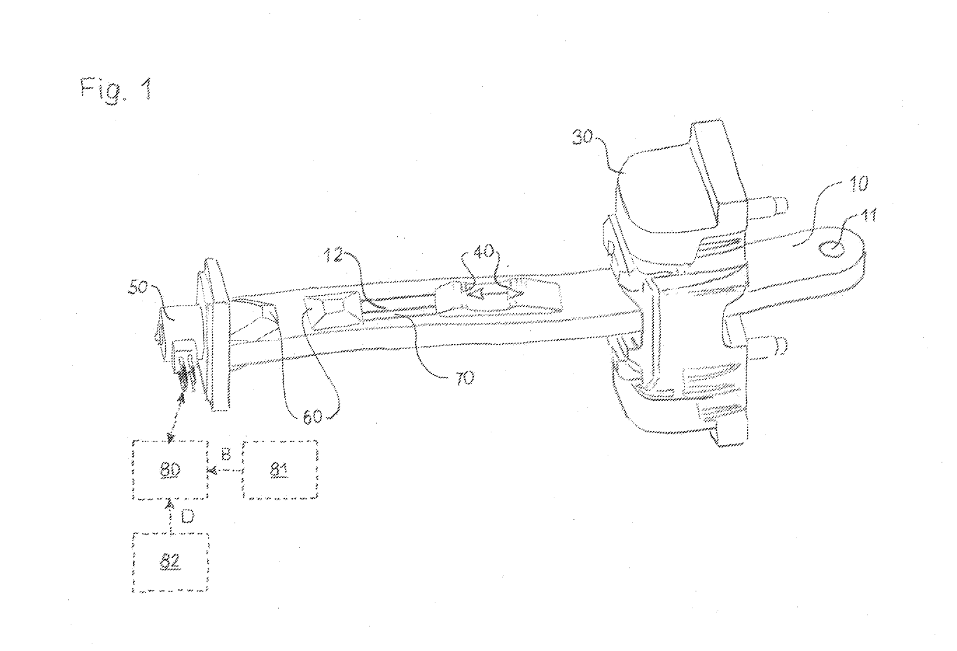

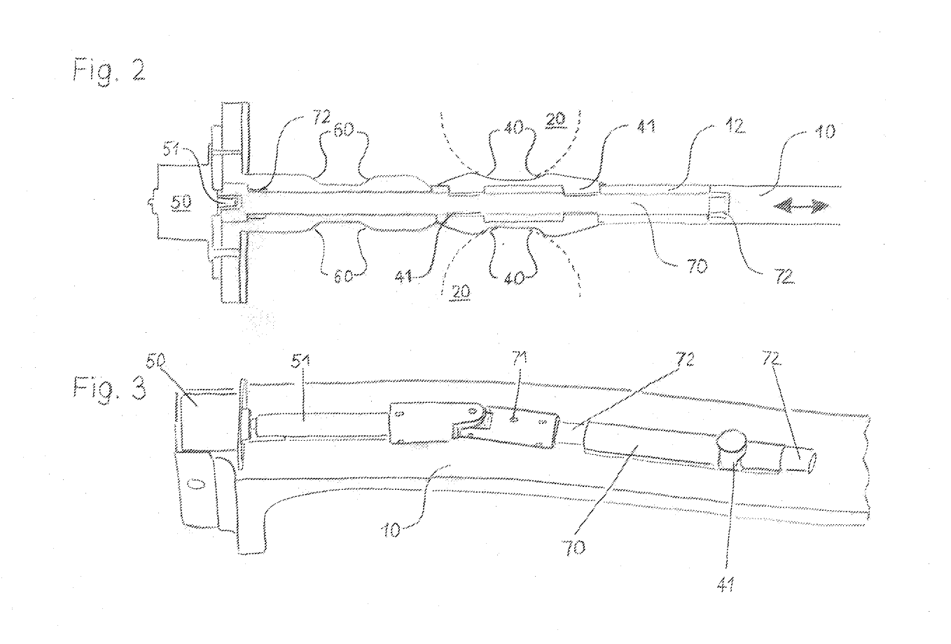

FIGS. 1 and 2 show a door brake system according to an embodiment of the present disclosure in a perspective view or an axial view. The door brake system includes a stop 20 denoted with a dashed line on FIG. 2, and a base body in the form of a retaining strap 10, which is hinged (in a manner not depicted) to a motor vehicle door, and for this purpose includes a borehole 11 (on the right of FIG. 1). As a consequence, it can be moved by a swiveling motion of the door relative to the stop 20 arranged on the body side.

The base body 10 is positively guided relative to the stop 10 by a guide 30, on which the stop 10 is flexibly arranged. The guide 30, and hence also the stop 10 flexibly arranged thereon, are arranged on a door frame of the vehicle body (not shown). As a consequence, the base body 10 can be displaced axially relative to the stop 20 by a swiveling motion of the door, as denoted by a double movement arrow on FIG. 2.

A dual-acting or two-sided counter-stop 40 is arranged on the base body 10. As evident in particular from FIG. 2, the counter-stop 40 brakes or locks the base body 10 in a brake or locked position relative to the stop 20 by the also dual-acting or two-sided stop 20, which in the brake or locked position interacts with it and contacts it. As a result, the counter-stop 40 also locks a corresponding swiveling motion of the door in a manner that is known, and hence not described in any more detail here.

The door brake system includes an actuator 50, with which the adjustable counter-stop 40 can be continuously and reversibly displaced on the base body 10, as denoted by a double movement arrow on FIG. 1. This adjustment allows a continuous adjustment of the brake and locked position of the base body 10 relative to the stop 20, and thus of a brake or locked position of the door. The adjustable counter-stop 40 is axially displaceably guided or slideably mounted on the base body in a positive manner by a groove 12 of the base body 10, in which two carriages 41 of the adjusted counter-stop 40 are guided.

The actuator 50 includes a drive shaft 51 driven by an electric motor, and is fastened to the base body 10 by being screwed to a side of the base body 10 facing away from the door (on the left of FIG. 1, 2).

The base body 10 includes an integrally designed, fixed, dual-acting or two-sided counter stop 60 spaced axially apart from the adjustable counter-stop 40 for braking or locking with the stop 20 that interacts with the fixed counter-stop 60 in a fixed brake or locked position differing from the adjustable brake or locked position. This fixed brake or locked position is arranged in the opening direction of the door before the adjustable brake or locked position defined by the adjustable counter-stop 40.

For braking or locking purposes, the stop 20, adjustable counter-stop 40 and fixed counter-stop 60 each include two opposite or oppositely inclined run-up surfaces or ramps. These ramps of the counter-stops are identified by reference numbers 40 or 60 on FIG. 2. As especially evident on FIG. 2, the stop 20, adjustable counter-stop 40 and fixed counter-stop 60 each include two contact surfaces for contacting the counter-stop or stop, which are arranged on sides of the base body 10 lying opposite each other (on the top and bottom of FIG. 2).

The door brake system includes a threaded spindle 70 for adjusting the adjustable counter-stop 40 via the actuator 50, which is rigidly, and hence operatively, connected with the drive shaft 51 of the actuator 50 for transmitting a torque around a longitudinal torque axis. The threaded spindle 70 includes a male thread, into which engage female threads on the carriages 41 of the adjustable counter-stop 40 guided in the groove of the base body 10, as a result of which the threaded spindle 70 is operatively connected with the adjustable counter-stop 40.

In another embodiment of the present disclosure shown on FIG. 3, the threaded spindle 70 is rotationally coupled with the actuator 50 by a cardan joint 71, and thereby operatively hinged with the latter. In this embodiment, the adjustable counter-stop 40 is also guided only by a carriage 41 in a groove 12 of the base body 10.

In addition, the base body 10 here has a two-part design. the upper half of the base body 10 is not displayed on FIG. 3 for illustrative purposes. By contrast, in the embodiment on FIG. 1, 2, the base body 10 is shaped as a single piece with the threaded spindle 70 slideably mounted in sliding bearings 72, and thereby integrated into the base body 10. In addition, the actuator 50 in the embodiment on FIG. 3 is placed in the two halves of the base body 10. Otherwise, this embodiment on FIG. 3 corresponds to the embodiment on FIG. 1, 2, so that both are described together or alternate reference is made to their respective description.

The stop 20 is flexibly mounted in the guide 30 in a known, and hence not depicted manner, and resultantly pre-tensioned against the base body 10 in an escape direction (vertically on FIG. 1, 2) transverse to the axial direction (horizontal on FIG. 1, 2) of the base body 10, so as to be able to yield to the counter-stops 40, 60 against the pre-tensioning and overcome or overrun the latter in this way.

The actuator 50 is electronically controlled by a controller denoted by a dashed line on FIG. 1 in the form of an ECU 80 as a function of a user input and/or an acquired obstacle. The adjustable brake position or locked position can advantageously be changed as desired with a user input B via the user input device 81 denoted by a dashed line on FIG. 1; for example, a swivel path between a closed position of the door and this position can be increased if needed, so as to facilitate entry and egress.

By making an adjustment as a function of an obstacle or a distance D to the latter, which is acquired by the sensor 82 denoted by a dashed line on FIG. 1, the controller 80 can advantageously determine the adjustable brake or locked position in such a way as to brake or lock the door before it reaches the obstacle. In particular, a swivel path between a closed position of the door and the adjustable brake or locked position can be diminished when an obstacle is acquired, so as to avoid a collision between the door and obstacle.

Even though exemplary embodiments were described in the preceding specification, let it be noted that a plurality of modifications are possible. For example, the base body 10 in the embodiment on FIG. 1, 2 can have a multi-part design, or conversely the base body in the embodiment on FIG. 3 can have a one-part design. In addition, the stop 20 and counter-stop 40 or 60 can also be arranged only on one side of the base body 10, for example only at the top or bottom on FIG. 2, 3. Instead of a lock provided by facing, opposing ramps, only a braking in a pull-out direction of the door can also be provided.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment, it being understood that various changes may be made in the function and arrangement of elements described in an exemplary embodiment without departing from the scope of the invention as set forth in the appended claims and their legal equivalents.

1-10. (canceled)

11. A door brake system for a door of a motor vehicle comprising:
a stop;
a base body configured to move relative to the stop;
an adjustable counter-stop arranged on the base body for braking a relative motion of the base body via the stop; and
an actuator for adjusting the counter-stop on the base body.

12. The door brake system according to claim 11, wherein the base body comprises a fixed counter-stop spaced apart from the adjustable counter-stop for braking a relative motion of the base body by the stop.

13. The door brake system according to claim 11, wherein the stop and at least one counter-stop are configured to lock the base body in a locked position.

14. The door brake system according to claim 11, further comprising a threaded spindle operatively connected with the actuator and the adjustable counter-stop for adjusting the adjustable counter-stop by the actuator.

15. The door brake system according to claim 12, wherein the threaded spindle is hingedly connected to the actuator.

16. The door brake system according to claim 12, wherein the threaded spindle is rigidly connected to the actuator.

17. The door brake system according to claim 12, wherein the threaded spindle is arranged in the base body.

18. The door brake system according to claim 17, wherein the threaded spindle is slideably mounted in at least two bearings.

19. The door brake system according to claim 11, wherein the stop and at least one counter-stop each comprise at least two contact surfaces, which are arranged on opposing sides of the base body.

20. The door brake system according to claim 11, wherein the stop is pre-tensioned against the base body.

21. The door brake system according to claim 11, further comprising a controller configured to control the actuator for adjusting the adjustable counter-stop as a function of a user input.

22. The door brake system according to claim 11, further comprising a controller configured to control the actuator for adjusting the adjustable counter-stop as a function of an acquired obstacle.

23. A motor vehicle comprising a body, a swivel-mounted door and a door brake system according to claim 11, wherein the base body is detachably fastened to one of the door or the body.

24. A motor vehicle comprising a body, a swivel-mounted door and a door brake system according to claim 11, wherein the base body is hingedly fastened to one of the door or the body.
